(19) United States
(12) Patent Application Publication
(10) Pub. No.: US 2026/0188883 A1
(43) Pub. Date: Jul. 2, 2026

(54) ANTI-VIBRATION WAVEGUIDE LOAD

(71) Applicant: Universal Microwave Technology, Inc., Keelung (TW)

(72) Inventors: TUNG-YI WU, Keelung (TW); JHIH-WEI WANG, Taipei (TW); HSUAN-WEI CHANG, Keelung (TW); MIN-JHE WONG, New Taipei (TW); SHIH-GONG CHIU, New Taipei (TW); MING-CHUN CHIANG, Yilan (TW)

(21) Appl. No.: 19/212,378

(22) Filed: May 19, 2025

Related U.S. Application Data
(60) Provisional application No. 63/740,247, filed on Dec. 30, 2024.

(51) Int. Cl. H01P 1/22; F16F 15/04; H01Q 13/28

(52) U.S. Cl. CPC H01P 1/222; F16F 15/04; H01Q 13/28

(57) ABSTRACT

An anti-vibration waveguide load includes a chamber, an upper cover and an absorber. The chamber includes a fixed portion. The upper cover configured to match with the chamber. The absorber configured in the fixed portion and includes a support section and an absorption section. The support section includes multiple snap-fit portions configured on a side of the support section, and produces an interference between each snap-fit portion and a wall surface of the fixed portion. The absorber abuts against the wall surface of the snap-fit portion in order to be fixed to the chamber. The absorption section is configured to extend from a side of the support section without having the snap-fit portion. In this way, the absorber can be stably arranged in the chamber of the anti-vibration waveguide load without using any adhesive, glue layer or other bonding structure.

### CROSS REFERENCE TO RELATED APPLICATIONS

The present application claims priority to U.S. Provisional Patent Application No. 63/740,247 filed on Dec. 30, 2024, the entire content of which is incorporated by reference to this application.

### BACKGROUND OF THE INVENTION

### Field of the Invention

The present invention relates to the technical field of wireless radio frequency, in particular to an anti-vibration waveguide load.

### Description of the Prior Art

In radio frequency (RF) signal transmission applications, waveguides are used to conduct electromagnetic energy, so that the electromagnetic energy can be transmitted to a specific location. In a waveguide, a load is typically configured at a terminal to absorb or consume the transmitted electromagnetic wave energy, avoiding the generation of reflected signal power or parasitic radiation within the waveguide, and thus preventing undesired interference in a RF transmission system.

Related-art waveguide loads are usually bonded to the absorber in a chamber by means of adhesive bonding, however, adhesive layers have a service life and is susceptible to accelerated aging due to temperature or other environmental factors, which can degrade the adhesive properties. Therefore, when the waveguide load is subject to vibration due to the external environment or other reasons, a poorly adherent adhesive layer will not easily allow the waveguide load to maintain sufficient stability in the chamber, which may result in a tuning fork effect within the waveguide load. The tuning fork effect may further cause structural damage or breakage of the waveguide load, or result in changes in the characteristics of the waveguide load (such as a reduced signal reflection). In addition, fractured fragments may even affect the utilization of the entire RF transmission system.

Obviously, an effective anti-vibration waveguide load is needed.

### SUMMARY OF THE INVENTION

The present invention allows a waveguide load to be securely configured in a chamber without the use of any adhesive, adhesive layer, or other bonding structure.

The present invention provides an anti-vibration waveguide load in which an internal absorber does not need a complex gluing process, a choice of gluing material (when a gluing material is used, additional consideration needs to be given to the matching of high-frequency signal parameters), and a fixation method using screws or the like.

The present invention provides an anti-vibration waveguide load for microwave products in the field of aerospace and satellite.

The anti-vibration waveguide load of the present invention, based on the configuration relationship of three side edges and one bottom side, allows the contact area between the absorber and the wall surface of the chamber of the waveguide load to be reduced, and then the absorber and the bottom side of the chamber of the waveguide load form a larger contact area, and such configuration can achieve the effect of suppressing the tuning fork effect.

The anti-vibration waveguide load of the present invention can be designed and manufactured more easily, and used in general microwave products, thus increasing product competitiveness through its solid anti-vibration effect.

According to some embodiments, the present invention provides an anti-vibration waveguide load, including: a chamber, an upper cover, and an absorber. The chamber includes a recessed fixed portion. The upper cover is configured to cooperate with the chamber. The absorber is configured to be within the fixed portion. The absorber is configured to include: a support section and an absorption section. The support section includes a plurality of snap-fit portions configured on a side, each snap-fit portion interferes with a wall surface of the fixed portion, and the absorber is fixed to the chamber by the abutment of each of the snap-fit portions against the wall surface of the fixed portion. The absorption section is configured to extend from a side of the support section which does not have the snap-fit section.

According to some embodiments, the support section includes a body portion and a protrusion, the absorption section is configured to extend from a front end of the body portion, and the protrusion is configured to extend from a rear end of the body portion, which is opposite to the front end.

According to some embodiments, the fixed portion includes four matching structures, two of the matching structures are provided for abutting the rear end of the body portion that does not have an absorption section, and the remaining two matching structures are provided for abutting the front end of the body portion and the protrusion.

According to some embodiments, the left and right sides of the body portion are configured with a first snap portion and a second snap portion, respectively, which gradually expand in a bottom-up direction away from the body portion. The protrusion is configured with a third snap portion on the side opposite to the front end of the body portion, which gradually expands in a bottom-up direction away from the protrusion. The absorber is fixed to the chamber by the abutment of the first snap portion, the second snap portion and the third snap portion against a wall surface of the fixed portion.

According to some embodiments, the first snap-fit portion, the second snap-fit portion, and the third snap-fit portion have a width in a bottom-up direction perpendicular to an extending direction of the first snap-fit portion and the third snap-fit portion. The width of the first snap-fit portion is configured to be substantially less than half of the width of a corresponding side of the body portion. The width of the second snap portion is configured to be substantially less than half of the width of a corresponding side of the body portion. The width of the third snap-fit portion is configured to be substantially less than half of the width of a corresponding side of the protrusion. In addition, at least one of the first snap portion, the second snap portion, and the third snap portion is configured to include a plurality of corresponding sub-portions. Each of the sub-portions includes the same progressive bevel structure from bottom to top. The sum of the respective widths of the sub-portions is configured to be substantially less than half of the width of the corresponding side.

According to some embodiments, the first snap portion, the second snap portion, and the third snap portion are all configured as a beveled structure all oriented upwardly and changing gradually from the second mounting surface.

According to some embodiments, the body portion and the protrusion have a side profile with an inclined direction that is different from the bevel structure of the corresponding first snap portion, second snap portion, and third snap portion, and the body portion and the protrusion have a side profile that gradually expands outwardly from top to bottom.

According to some embodiments, the top edges of the first snap-fit portion and the second snap-fit portion are configured to be lower than a top side of the body portion and respectively form a first depression and a second depression. The top edge of the third snap-fit portion is configured to be lower than the top side of the protrusion and correspondingly form a third depression.

According to some embodiments, a wall surface of the fixed portion includes a first flange that correspondingly matches a first depression in a positional relationship, a second flange that correspondingly matches a second depression, and a third flange that correspondingly matches a third depression. The first flange forms an interference with the first snap portion, the second flange forms an interference with the second snap portion, and the third flange forms an interference with the third snap portion. The absorber is confined in the fixed portion by the first flange, the second flange, and the third flange.

According to some embodiments, the first flange, the second flange, and the third flange are configured to protrude substantially from the wall surface of the fixed portion by 0.05 mm to 0.15 mm.

According to some embodiments, the bottom side of the absorbing section is a first mounting surface and the bottom side of the supporting section is a second mounting surface. The first mounting surface, the second mounting surface, and the bottom side of the fixed portion are substantially flat abutment structures. The absorber is supported against the bottom side of the fixed portion of the chamber by the first mounting surface and the second mounting surface.

According to some embodiments, the body portion is configured to be substantially rectangular. A maximum height of the bevel structure of the absorption section and a height of the protrusion are configured such that both are substantially flush with a top side of the body portion.

According to some embodiments, an absorber section extending from the support section is configured to exhibit a bevel structure with a gradually decreasing height on a surface opposite to the first mounting surface. Both sides of the absorption section are tapered and a pointed and thin end is formed thereon in a direction away from the support section.

### BRIEF DESCRIPTION OF THE DRAWINGS

FIG. 1 is an isometric view of an absorber in an anti-vibration waveguide load in accordance with an embodiment of the present invention.

FIG. 2 is a top view of the absorber of FIG. 1.

FIG. 3 is a right side view of the absorber of FIG. 1.

FIG. 4 is a left side view of the absorber of FIG. 1.

FIG. 5 is a front side view of the absorber of FIG. 1.

FIG. 6 is a rear side view of the absorber of FIG. 1.

FIG. 7 is a bottom view of the absorber of FIG. 1.

FIG. 8 is another isometric view of the absorber of FIG. 1.

FIG. 9 is a further isometric view of the absorber of FIG. 1.

FIG. 10 is a top view of an absorber in a chamber of an anti-vibration waveguide load in accordance with an embodiment of the present invention.

FIG. 11 is an exploded view of an anti-vibration waveguide load in accordance with an embodiment of the present invention.

FIG. 12 is a top view of the anti-vibration waveguide load of FIG. 11.

FIG. 13 is a cross-sectional view of the Section A-A of FIG. 12.

FIG. 14 is a cross-sectional view of the Section B-B of FIG. 12.

FIG. 15 is a perspective view of the chamber of the anti-vibration waveguide load of FIG. 11.

FIG. 16 is a perspective sectional view of the chamber of the anti-vibration waveguide load of FIG. 11.

FIG. 17 is a front view of FIG. 16.

### DESCRIPTION OF THE PREFERRED EMBODIMENTS

The technical characteristics, contents, advantages and effects of the present invention will become apparent from the following detailed description taken with the accompanying drawing.

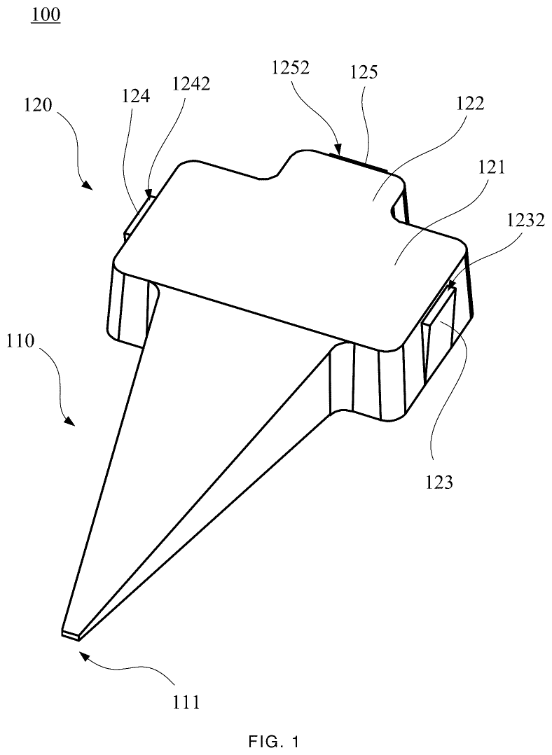

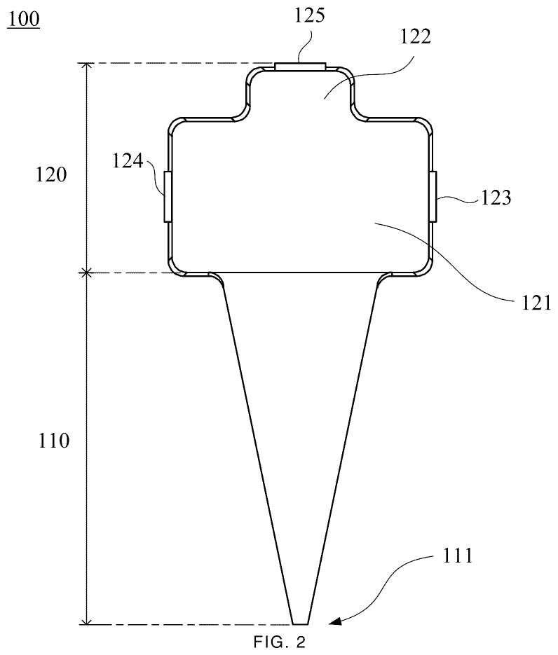

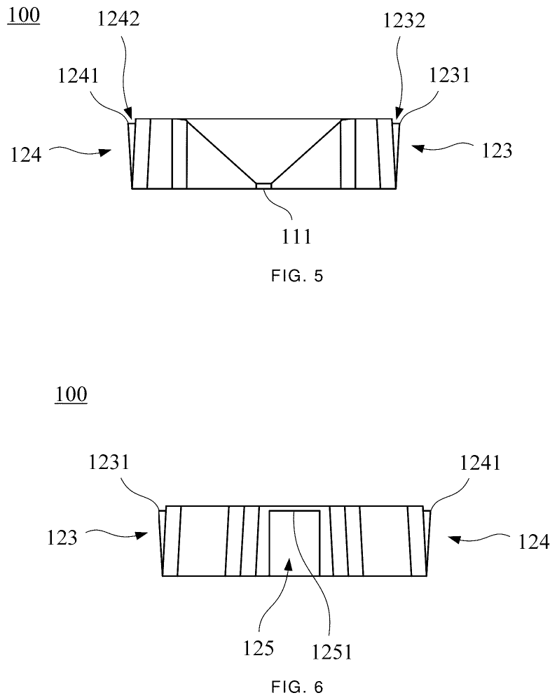

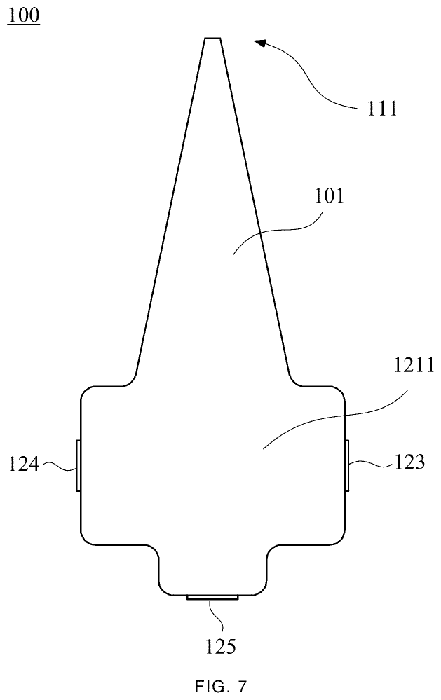

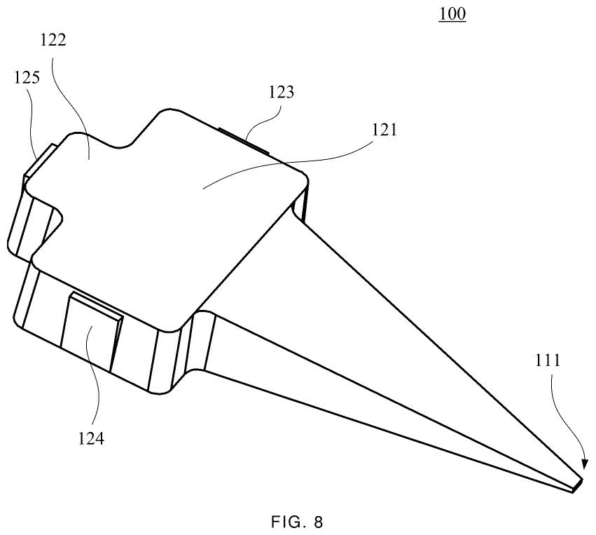

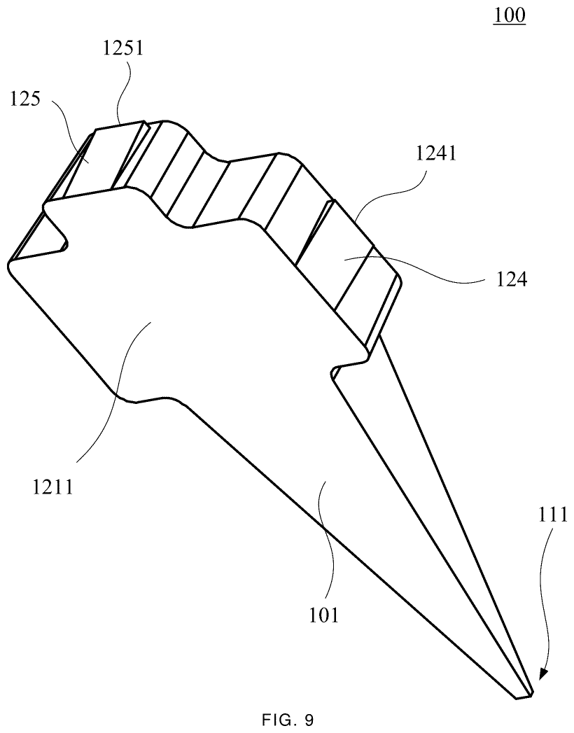

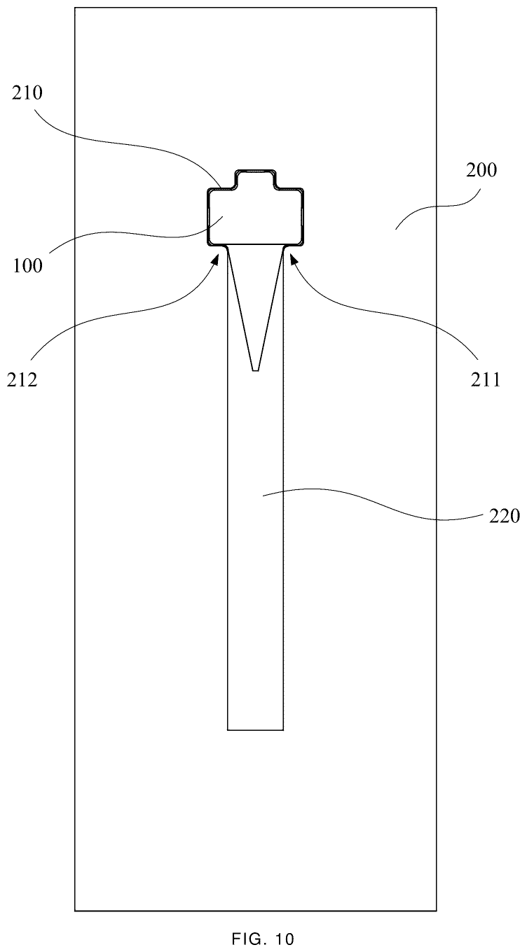

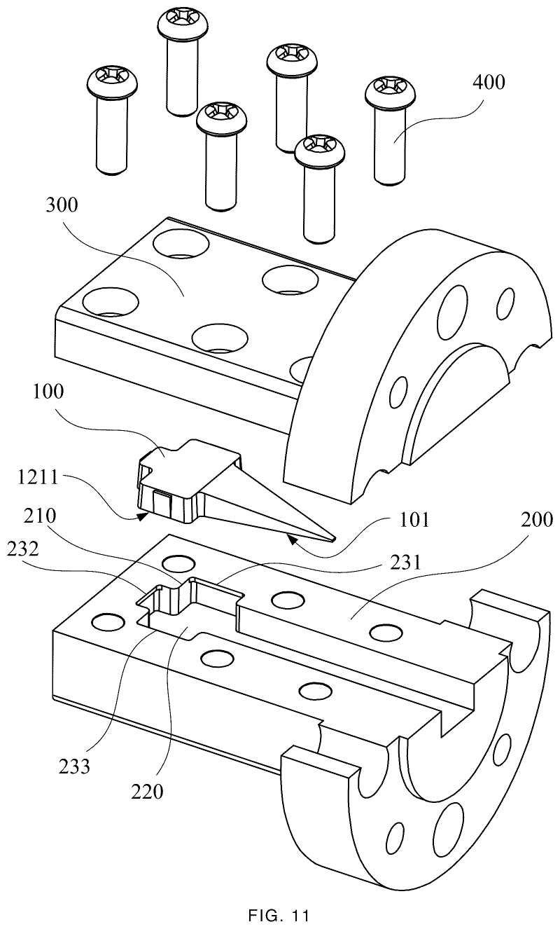

With reference to FIGS. 1 to 9 for an embodiment of an absorber 100 in an anti-vibration waveguide load, the absorber 100 in the anti-vibration waveguide load as shown in FIG. 2 includes an absorption section 110 and a support section 120. The absorption section 110 is provided for absorbing electromagnetic wave energy in the waveguide. The support section 120 is provided for stably fixing the absorber 100 to a fixed portion 210 inside the chamber 200 and having the shape matched with the support section 120 of the absorber 100 as shown in FIG. 10. The fixed portion 210 in the chamber 200 as shown in FIG. 10 is in an inwardly concave shape to provide the space for fixing the absorber 100 into the chamber 200.

The structure of the absorption section 110 of the absorber 100 is a structure with a gradually decreasing height extending from the support section 120 in a direction away from the support section 120. The progressive bevel structure is provided for absorbing the electromagnetic wave energy in the waveguide, as well as effectively reducing signal reflection. In addition, the absorption section 110 may further form a tapering shape on both sides and gradually approach in an upward direction away from the support section 120, and exhibit a shape and thin end 111 at the foremost end of the absorption section 110.

The absorption section 110 is configured to extend from a part of the side edge of the support section 120 only, rather than the whole side edge of the support section 120. In the same time, the fixed portion 210 in the chamber 200 comes with a matched shape. Each of the two sides of the absorption section 110 are additionally formed with a matching structure 211, 212 (as shown in FIG. 10) for improving the anti-vibration performance. The matching structure 211, 212 is provided for abutting the absorber 100. In FIGS. 1 and 10, the two matching structures 211, 212 abut against the rear end of the support section 120 and abut against both sides of the absorption section 110.

The bottom side of the absorption section 110 is a first mounting surface 101 which is approximately a flat surface, and the bottom side 220 of the chamber 200 of the anti-vibration waveguide load is also approximately a flat surface. Therefore, the absorption section 110 can abut against the bottom side 220 of the chamber 200 via the first mounting surface 101.

The end 111 of the front end of the absorption section 110 can abut against the bottom side 220 of the chamber 200. With such abutment, even if the waveguide load is subjected to a large vibration, the end 111 is not easily damaged by the vibration. This also strengthens the rigidity of the fragile tip. In general, the appearance of the absorption section 110 presents a progressive wedge-shaped structure with a thin tip and a thick wide base.

The support section 120 includes a body portion 121 and a protrusion 122. The body portion 121 is slightly a rectangular, and the absorption section 110 extends from the middle of the front end of the body portion 121. The bottom side of the body portion 121 is second mounting surface 1211 which is substantially flat and capable of abutting against the bottom side 220 of the chamber 200. The protrusion 122 extends from the middle of the rear end of the body portion 121. The maximum height of the absorption section 110 and the height of the protrusion 122 are flush with the top side of the body portion 121.

Both sides of the body portion 121 are configured with a first snap-fit portion 123 and a second snap-fit portion 124, which gradually expand in a bottom-up direction away from the body portion 121. On the protrusion 122 and at the rearmost end of the support section 120, a third snap-fit portion expanding in a bottom-up direction 125 is configured to exhibit a gradual structure.

Specifically, these snap-fit portions 123, 124, 125 are configured to be progressive bevel structures extending upwardly from the second mounting surface 1211 of the support section.

When the absorber 100 is placed in the chamber 200 of the anti-vibration waveguide load, since the chamber 200 is provided with a fixed portion 210 matching the appearance of the support section 120 of the absorber 100, the snap-fit portions 123, 124, 125 on the outermost convex edges (1231, 1241, 1251) can slightly interfere with the wall surface of the chamber of the anti-vibration waveguide load (extremely small tolerance, for example: interference degree of 0.005 mm˜0.015 mm), thereby providing a tight snap-fit effect.

In some embodiments, the most outwardly convex edge (1231, 1241, 1251) is less than a half of each corresponding side edge. For example, the length d1 of the edge 1231 does not exceed the length d2 of the corresponding side of the body portion 121.

The first snap-fit portion 123, the second snap-fit portion 124 and the third snap-fit portion 125 provide a stable three-side edge structure, and the first mounting surface 101 and the second mounting surface 1211 can establish a nearly close-fitting abutting relationship with the bottom side 220 of the chamber 200. Based on the configuration of the three side edges plus the bottom side 220, the absorber 100 can be firmly fixed in the chamber 200 of the anti-vibration waveguide load, and provides both wave absorbing and anti-vibration effects without requiring any adhesive, glue layer or other bonding structure.

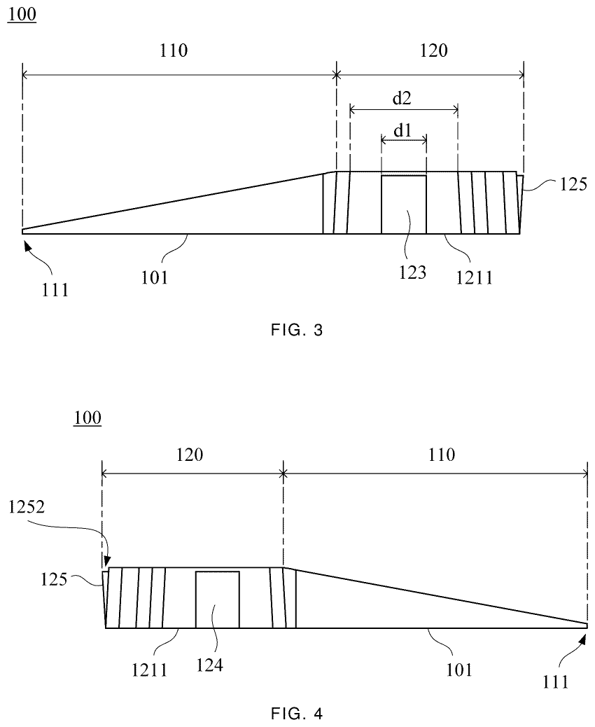

In some embodiments, the side edges of the body portion 121 and the protrusion 122 have an inclination direction opposite to that of the progressive bevel structure of the first snap-fit portion 123, the second snap-fit portion 124 and the third snap-fit portion 125. As shown in FIGS. 3 to 6, the progressive bevel structures of the first snap-fit portion 123, the second snap-fit portion 124 and the third snap-fit portion 125 gradually expand from bottom to top, while the body portion 121 and the protrusion 122 gradually expand from top to bottom on the side to form a bevel structure with a narrow top and a wide bottom. The progressive bevel structures of the body portion 121 and the protrusion 122 provide an advantage for manufacture, and can facilitate the demolding process in an injection molding manufacturing process when these structures are implemented. However, the present invention is not limited to manufacturing the absorber 100 by injection molding, and other processing methods such as CNC processing or other processing methods can also be used for the manufacturing of the absorber 100.

In some embodiments, each snap-fit portion may also be divided into a plurality of sub-portions, each sub-portion being disposed on a corresponding side. For example, the first snap-fit portion 123 includes two sub-portions, each sub-portion being located on the same side of the body portion 121 and having the same progressive bevel structure.

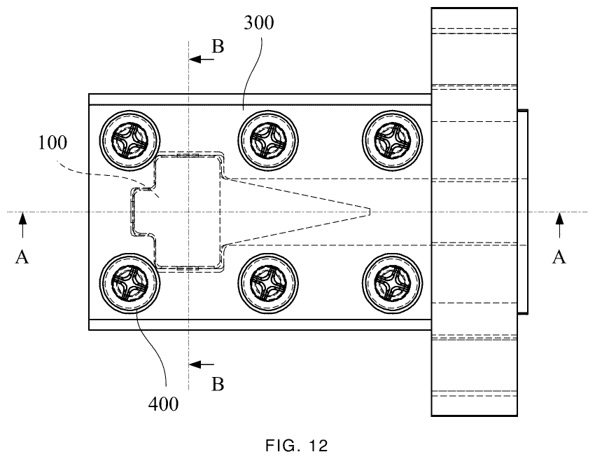

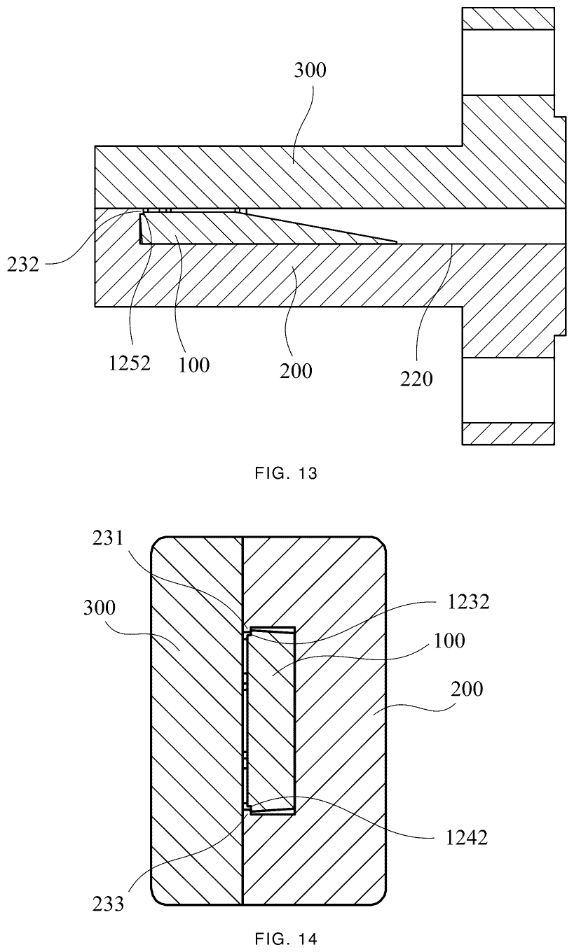

In the embodiments as shown in FIGS. 11 to 17, the chamber 200 and the upper cover 300 of the anti-vibration waveguide load are locked by a locking element 400, and the absorber 100 is tightly engaged in the chamber 200. By means of the fixed portion 210 of the chamber 200 in the shape matching with the shape of the support section 120 of the absorber 100, the absorber 100 can be tightly engaged therein. In addition, the first mounting surface 101 and the second mounting surface 1211 of the absorber 100 are in contact with the bottom side 220 of the chamber 200 in an equivalently, approximately, or substantially flat manner, so that the overall structure can absorb waves and resist vibration.

In FIGS. 1, 4 and 5, the top edges of the first snap-fit portion 123 and the second snap-fit portion 124 can be configured to be lower than the top side of the body portion 121, and the top edge of the third snap-fit portion 125 can be configured to be lower than the top side of the protrusion 122. Such a configuration allows the first snap-fit portion 123, the second snap-fit portion 124 and the third snap-fit portion 125 to be formed above the first depression 1232, the second depression 1242 and the third depression 1252 respectively.

In FIGS. 11, 13, 14, 15, 16 and 17, the chamber 200 includes a first flange 231, a second flange 232 and a third flange 233 formed on the wall surface of the fixed portion 210 and matched with the first depression 1232, the second depression 1242 and the third depression 1252 respectively. These flanges (231, 232, 233) provide additional slight interference to the absorber 100 (for example, the mutually interfered overlapping width d3 is about 0.05 mm˜0.15 mm), so that these flange structures (231, 232, 233) can provide additional limiting and fixing capabilities to the absorber 100.

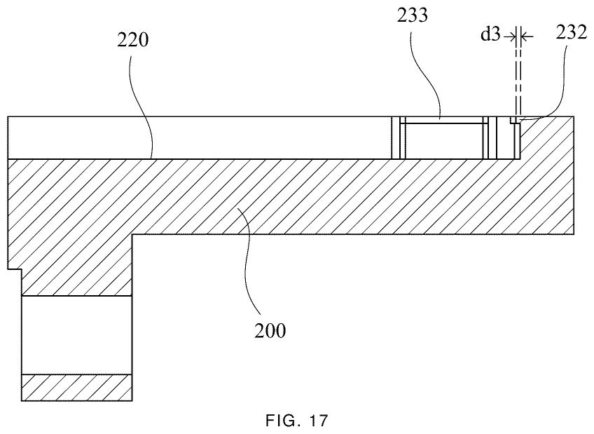

For further illustration by means of selected viewing angles as shown in FIGS. 16 and 17, the interfered overlapping width can be defined by the extent to which the flange structures (231, 232, 233) protrude from the wall surface of the chamber 200. Due to the viewing angle and the cross-sectional direction only the second flange 232 and the third flange 233 are shown in FIGS. 16 and 17.

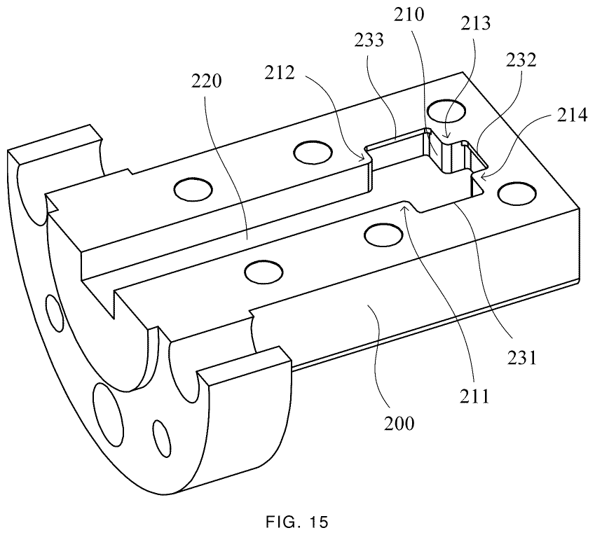

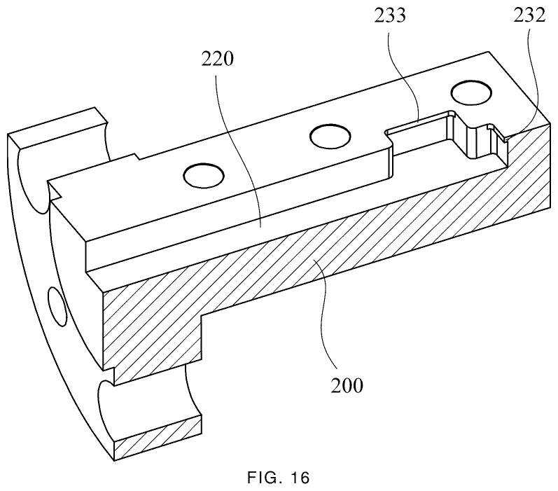

In FIG. 15, when the absorber 100 (not shown in the figure) is placed in the fixed portion 210, the matching structure 211, 212, 213, 214 of the chamber 200 can provide a preliminary limiting and fixing effect for the absorber 100. In other words, the fixed portion 210 of some embodiments may include four matching structures as shown in FIG. 15, the matching structures 211, 212 may provide abutment for the rear end of the body portion 121 and the portion without the absorption section 110, and the matching structures 213, 214 may provide abutment for the front end of the body portion 121 and the protrusion 122. In addition, the absorber 100 interferes with the wall surface of the chamber 200 at the edges (1231, 1241, 1251) of the snap-fit portions 123, 124, 125. In addition, the absorber 100 has an excellent anti-vibration capability due to the interference formed by the edges (1231, 1241, 1251) of the snap-fit portions 123, 124, 125 on the wall surface of the chamber 200 and these flanges (231, 232, 233) provide a further limiting and fixing effect formed by the interference produced by the flange structures (231, 232, 233) above the absorber 100.

In the above disclosure, the terms “approximately”, “about”, “close”, “substantially” or “essentially” are normally used to refer to “any approximation of a given value” or “any approximation of a given range”. In particular, these approximations may vary depending on the field of interest, and the range of variation should be consistent with the broadest interpretation understood by those having ordinary skill in the art to cover similar implementations and all modifications based on such variations. In some implementations, this should typically mean within 20% of a “given value” or “given range”, further within 10%, and even further within 5%. The numerical quantities given herein are approximate, meaning that if not explicitly stated, it can be inferred that these numerical quantities are categorized as “approximately”, “about”, “close to”, “substantially”, or “essentially”, or other approximations are included.

The present invention is illustrated by various aspects and embodiments. However, persons skilled in the art understand that the various aspects and embodiments are illustrative rather than restrictive of the scope of the present invention. After perusing this specification, persons skilled in the art may come up with other aspects and embodiments without departing from the scope of the present invention. All equivalent variations and replacements of the aspects and the embodiments must fall within the scope of the present invention. Therefore, the scope of the protection of rights of the present invention shall be defined by the appended claims.

What is claimed is:

1. An anti-vibration waveguide load, comprising:
a chamber, with a recessed fixed portion;
an upper cover, configured to match with the chamber; and
an absorber, configured in the fixed portion, and comprising:
a support section, comprising a plurality of snap-fit portions configured on a side thereof, an interference being formed between each snap-fit portion and a wall surface of the fixed portion, and the absorber abutting against the wall surface of the fixed portion in order to be fixed to the chamber through each snap-fit portion; and
an absorption section, extending from a side of the support section without having the snap-fit portion.

2. The anti-vibration waveguide load according to claim 1, wherein the support section comprises a body portion and a protrusion, the absorption section extends from a front end of the body portion, and the protrusion extends from a rear end of the body portion opposite to the front end.

3. The anti-vibration waveguide load according to claim 2, wherein the fixed portion comprises four matching structures, two of the matching structures are provided for abutting against the rear end of the body portion and the portion without having the absorption section, and the remaining two matching structures are provided for abutting against the front end of the body portion and the protrusion.

4. The anti-vibration waveguide load according to claim 3, wherein both left and right sides of the body portion are configured with a first snap-fit portion and a second snap-fit portion which gradually and outwardly expand from bottom to top and in a direction away from the body portion, a side of the protrusion opposite to the front end of the body portion is configured with a third snap-fit portion which outwardly expands from bottom to top and in a direction away from the protrusion, and the absorber abuts against the wall surface of the fixed portion in order to be fixed to the chamber through the first snap-fit portion, the second snap-fit portion and the third snap-fit portion.

5. The anti-vibration waveguide load according to claim 4, wherein the first snap-fit portion, the second snap-fit portion and the third snap-fit portion have a width in a direction perpendicular to their extending direction from bottom to top, the width of the first snap-fit portion is substantially less than a half of the width of the side of the corresponding body portion, the width of the second snap-fit portion is substantially less than a half of the side of the corresponding body portion, and the width of the third snap-fit portion is substantially less than a half of the width of the side of the corresponding protrusion.

6. The anti-vibration waveguide load according to claim 5, wherein at least one of the first snap-fit portion, the second snap-fit portion and the third snap-fit portion comprises a plurality of sub-portions, the sub-portions comprise the same progressive bevel structures from bottom to top, and the sum of the widths of the sub-portions is substantially less than a half of the width of the corresponding side.

7. The anti-vibration waveguide load according to claim 4, wherein the first snap-fit portion, the second snap-fit portion and the third snap-fit portion are bevel structures which gradually change upward from the second mounting surface.

8. The anti-vibration waveguide load according to claim 7, wherein the body portion and the protrusion have a side profile with an inclined direction that is different from the bevel structure of the corresponding first snap portion, second snap portion, and third snap portion, and the body portion and the protrusion have a side profile that gradually expands outwardly from top to bottom.

9. The anti-vibration waveguide load according to claim 4, wherein the top edges of the first snap-fit portion and the second snap-fit portion are configure to be lower than the top side of the body portion to form a first depression and a second depression respectively, and the top edge of the third snap-fit portion is configured to be lower than the top side of the protrusion to form a third depression correspondingly.

10. The anti-vibration waveguide load according to claim 9, wherein the wall surface of the fixed portion comprises a first flange matched with the first depression, a second flange matched with the second depression, a third flange matched with the third depression, the first flange produces an interference with the first snap-fit portion, the second flange produces an interference with the second snap-fit portion, the third flange produces an interference with the third snap-fit portion, and the absorber is confined within the fixed portion by the first flange, the second flange and the third flange.

11. The anti-vibration waveguide load according to claim 10, wherein the first flange, the second flange and the third flange protrude out from the wall surface of the fixed portion by substantially 0.05 mm˜0.15 mm.

12. The anti-vibration waveguide load according to claim 4, wherein the bottom side of the absorption section is a first mounting surface, the bottom side of the support section is a second mounting surface, the first mounting surface, the second mounting surface and the bottom side of the fixed portion are substantially flat abutting structures, and the absorber abuts against the bottom side of the fixed portion of the chamber through the first mounting surface and the second mounting surface.

13. The anti-vibration waveguide load according to claim 12, wherein the body portion is substantially rectangular, the maximum height of the bevel structure of the absorption section and the height of the protrusion are substantially flush with the top side of the body portion.

14. The anti-vibration waveguide load according to claim 13, wherein the absorption section extending out from the support section is a bevel structure formed on a side opposite to the first mounting surface and exhibiting a gradually decreasing height, and both sides of the absorption section are tapered and provided with a pointed and thin end configured in a direction away from the support section.
